(19) United States
(12) Patent Application Publication
(10) Pub. No.: US 2010/0119306 A1
(43) Pub. Date: May 13, 2010

(54) Ground thawing mat and apparatus for making same

(76) Inventor: Randy Albert, Calgary (CA)

Correspondence Address: Antony C. Edwards, P.O. Box 26020, Westbank, BC, V4T 2G3, CA

(21) Appl. No.: 12/289,973

(22) Filed: Nov. 7, 2008

(51) Int. Cl. B67D 5/63

(52) U.S. Cl. 405/131; 29/890.09

(57) ABSTRACT

A ground thawing mat includes at least a flexible upper sheet overlaying a serpentine twinned array of flexible heating fluid conduits, wherein the twinned array include at least a closely adjacent and parallel pair of conduits extending from a heating fluid inlet entering the parallel pairs of conduits to a heating fluid outlet exiting the parallel pair of conduits, and wherein the parallel pair of conduits extend substantially linearly without crossing one another between opposed serpentine turns. Further, the parallel pair of conduits turn through the turns without crossing one another so that the twinned array lie substantially in a single plane overlaid by the upper sheet.

### FIELD OF THE INVENTION

This invention relates to the field of devices used to thaw frozen ground by heating the exposed surface of the frozen ground, and in particular to the field of thaw mats employing flexible heating fluid conduits in the mat.

### BACKGROUND OF THE INVENTION

There have been various attempts in the prior art to provide effective and efficient ground thawing equipment using for example heated fluids which are pumped through serpentine tubing disposed in a layer adjacent or directly on top of the frozen ground surface. It is known to provide the serpentine tubing within an encasing sandwich construction which may be flexible and may incorporate an insulating layer on the side of the serpentine tubing opposite from the side exposed to the ground, and which is flexible so as to be rolled up when not in use or when removed after thawing has been completed. It is also known to provide heat reflective layers above the serpentine tubing and to provide for sealing around the edges of the serpentine construction to inhibit the intrusion of cold air between the serpentine tubing layer and the frozen ground. It is acknowledged in the prior art that the thawing of the ground by these prior art devices may require at least several days to thaw the ground to a useful depth depending on such factors as obviously the depth of the frost layer in the ground, the outside temperature, and the particular prior art technology being employed.

In the prior art applicant is aware of International Patent Application No. PCT/US98/25477 published under International Publication No. WO99/28560 on Jun. 10, 1999 for the invention of Erickson et al for a Ground Thawing Apparatus and Method. Erickson discloses the use of a thaw mat having a flexible heating conduit held in a pre-arranged configuration and having a lower surface oriented toward the ground wherein a flexible insulative batting overlays the heating fluid conduit which may be pre-arranged in a serpentine configuration extending the majority of the length of the thaw mat and wherein a lower surface of a base fabric may be provided with an infrared reflective coating in the form typified as a reflective foil lining, and wherein the mat may be provided with a peripheral seal which lies in direct contact with the ground. The heating fluid conduit is taught as being capable of being repeatably flexibly deformed as a unit into a compact configuration and deployed as a unit over ground to be thawed as for example where the mat is stored on a reel and unrolled from the reel to deploy it over the ground.

Also in the prior art applicant is aware of U.S. Pat. No. 3,105,134 which issued to Liu on Sep. 24, 1963 for a Heat Conductive Ground Cover, U.S. Pat. No. 4,305,681 which issued to Backlund on Dec. 15, 1981 for a Method and Apparatus for Controlling the Temperatures of Asphalt Bodies and Concrete Bodies, U.S. Pat. No. 4,510,920 which issued to Walmet on Apr. 16, 1985 for a Heat Exchanger Mat, U.S. Pat. No. 4,984,594 which issued to Vinegar et al on Jan. 15, 1991 for a Vacuum Method for Removing Soil Contamination Utilizing Surface Electrical Heating.

### SUMMARY OF THE INVENTION

In summary the ground thawing mat according to the present invention may be characterized in one aspect as including at least a flexible upper sheet overlaying a serpentine twinned array of flexible heating fluid conduits, wherein the twinned array include at least a closely adjacent and parallel pair of conduits extending from a heating fluid inlet entering the parallel pairs of conduits to a heating fluid outlet exiting the parallel pair of conduits, and wherein the parallel pair of conduits extend substantially linearly without crossing one another between opposed serpentine turns. Further, the parallel pair of conduits turn through the turns without crossing one another so that the twinned array lie substantially in a single plane overlaid by the upper sheet.

In one embodiment the mat further includes a flexible lower sheet. The twinned array of conduits overlays the lower sheet so as to be interleaved between the upper and lower sheets. The twinned array of conduits are fastened by fasteners to the lower sheet.

Advantageously an insulating layer is interleaved between the twinned array of conduits and the upper sheet. Further, a heat reflective foil sheet may be interleaved between the twinned array of conduits and the insulating layer. The upper and lower sheets may have contiguous circumferential edges, wherein the edges of the upper and lower sheets are joined to substantially seal the edges together.

The fasteners may include straps mounted to the lower sheet so as to form loops snugly looping over the twinned array of conduits. The straps may be spaced part along the length of the twinned array. The straps may be a spaced apart array of straps extending across the twinned array.

In one embodiment the upper and lower sheets are substantially rectangular and the conduits extend substantially linearly in a longitudinal direction relative to the upper and lower sheets, and the serpentine turns are disposed at opposite longitudinal ends of the upper and lower sheets. The array of straps may be spaced apart longitudinally along the lower sheet and each strap of the array of straps may extend so as to form a plurality of the loops over the substantially linearly extending conduits. Further, end fasteners may secure the serpentine turns to the lower sheet. The end fasteners may be short lengths of strapping mounted at ends thereof to the lower sheet at the serpentine turns so as to form a loop over each turn of the serpentine turns.

According to a further aspect of the invention, a method of making a ground thawing mat such as described above includes the steps of:
a) providing a spaced apart pair of tube tensioning jigs having turn forming means on each jig of the pair of tube tensioning jigs,
b) providing a pair of lengths of the tubes,
c) aligning the pair of lengths of the tubes so as to be closely adjacent and parallel,
d) feeding the pair of lengths of the tubes in a serpentine path alternatingly through opposite turn forming means so as to alternatingly form the serpentine turns in the twinned array of tubes and so as to form the twinned array in the single plane overlaid by the upper sheet and so as to not cross one tube over the other.

The method may further include providing a flexible lower sheet and positioning the jigs at opposite ends of the lower sheet and overlaying the twinned array of conduits onto the lower sheet so as to be tensioned between the jigs and thereafter fastening the twinned array of the tubes by fasteners to the lower sheet and interleaving the twinned array between the upper and lower sheets.

The method may also further include the following steps:
a) interleaving an insulating layer between the twinned array of the tubes and the upper sheet.
b) interleaving a heat reflective foil sheet between the twinned array of the tubes and the insulating layer
c) sealing together contiguous circumferential edges of the upper and lower sheets.
d) forming loops by snugly looping the straps over the twinned array of the tubes spaced apart along the length of the twinned array.
e) extending the straps across the twinned array in a spaced apart array of straps.
f) providing end fasteners and securing the serpentine turns to the lower sheet.

### BRIEF DESCRIPTION OF THE DRAWINGS

In the drawings where in similar characters of reference to note corresponding parts in each view,

FIG. 1 is, in partiality cut-away from perspective view, a ground thawing mat according to one embodiment of the present invention.

FIG. 2 is the in partiality assembled mat of FIG. 1.

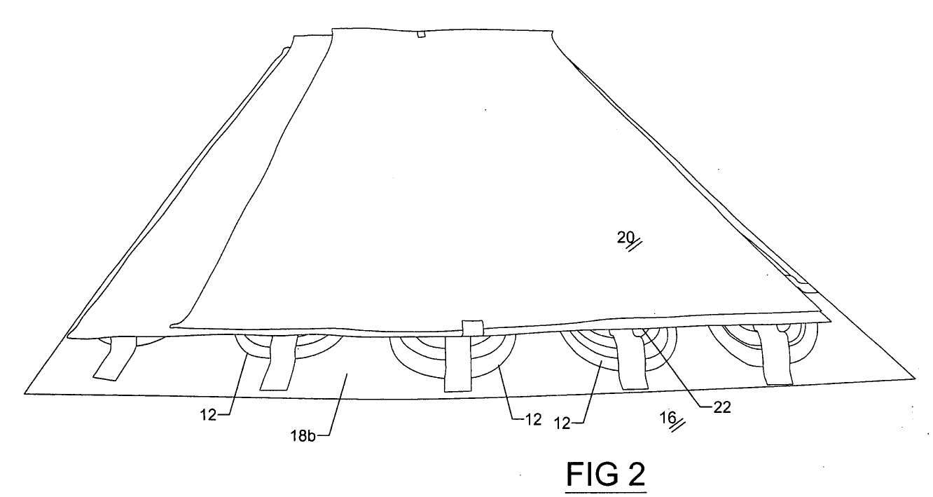

FIG. 3 is the fully assembled mat of FIG. 1.

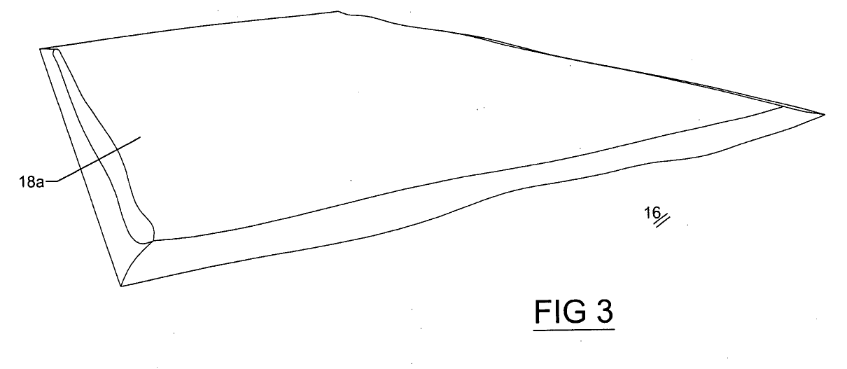

FIG. 4 is, in front perspective view, the initial assembly of a ground thawing mat with out the tube-twining according to the present invention.

FIG. 5 is, in front perspective view, a partially assembled mat according to the present invention showing the twinned tubes.

### DETAILED DESCRIPTION OF EMBODIMENTS OF THE INVENTION

It has been Applicant's experience that the thawing time per unit volume of frozen ground and in particular, the time to thaw the frozen moisture held within the frozen soil per unit volume is by and large a direct function of the amount of heat per unit of exposed surface area on the ground which may be brought to bare and inversely proportional to the distance between the heat supply and the surface of the ground being thawed. It is also the function of the rate with which the heated fluid is replaced as it is cooled by transfer of energy to the ground.

Thus in the use serpentine cooling, increasing the number of tubes carrying heated fluid per unit area while maintaining the spacing between the tubing and the ground at a minimum and preferably in, if not direct contact, then very nearly direct contact only separated by a thin flexible sheet, is desirable.

Thus in the design according to a preferred embodiment of the present invention, a thawing mat 10 including serpentine tubing 12 is provided in at least twinned parallel tube arrays 14 to increase the density of the length of tubing per unit area of mat 10 to thereby increase, for example doubling, the heat transfer rate per unit area from the serpentine tubing carrying the heated fluid to the surface 16 of the frozen ground.

In the present invention a ground thawing system is comprised of arrays of mats 10 which may be adjoined along their edges and ends, and adjoined end to end provide heated strips. The strips may be laid side by side so as to provide a heated blanket comprising cooperating modular mats 10 and strips of mat 10. Individual mats 10 may be connected in fluid communication with adjacent mats in the strip by means known in the art such as flow splitters or headers so that a fluid heater such as a conventional boiler and a pump which may be located in proximity to the mats, for example on a trailer, may pump heated fluid through the inter-connected mats. The fluid may be such as a heated water and Glycol mixture in a closed loop system from the pump. Thus cooled fluid is returned from the down stream end of the serpentine tubing 12 within mats 10 to the inlet of the boiler. The fluid is then reheated in the boiler and passed from the outlet of the boiler to the inlet of the pump. The pump pressurizes the fluid and forces the heated fluid from the outlet of the pump and into the inlet of a first or upstream mat, and in particular into the inlet of the serpentine tubing within the first mat for passing of the heated fluid through the serpentine tubing and out from the outlet of the serpentine tubing in the first mat to the inlet of the serpentine tubing in the second mat and so on until the fluid leaves the outlet of the last mat in the array to return to the boiler.

Advantageously, the heated fluid may be pumped at a rate of approximately 34 United States gallons per minute or under a pressure of approximately 18 psi. Advantageously, the boiler heats the fluid to approximately 190 degrees Fahrenheit. This volume flow rate at this temperature provides a sufficiently heated heat transfer fluid as it passes through a long length of serpentine tubing so as to efficiently thaw the ground even where the total length of the serpentine tubing may be in the order of 800 feet of tubing for example in a 20 foot by 20 foot dimension array of mats. The tubing may advantageously be ½ inch inside diameter and having for example a wall thickness of approximately ⅛ of an inch. Each mat may be for example 5 feet wide by 20 feet long.

The mat 10 provides a sandwich construction sandwiching the serpentine tubing 12 in a single planer layer between the flexible upper and lower sheets 18a and 18b respectively of the mat. Preferably the upper and lower sheets of the mat are made from 18 ounces of PVC Polyester fabric, which retains its flexibility at low temperature to −40 and may be purchased commercially from Inland Plastic under the trade name IP 18E PVC Polyester Scrim. Preferably a thin insulating layer 20 such as sheets of bubble-packaging is interleaved between the layer of serpentine tubing 12 and the upper sheet 18a of the mat so as to insulate the serpentine tubing from upward exposure to the environment when the mats are laid on the surface of the frozen ground. Further advantageously a heat reflective layer or sheet 22 is interleaved between the insulating layer and the layer of serpentine tubing. For example sheet 22 may be metal or metal backed foil such as made by CAN-CELL and sold under the Trade-mark Flexfoil by Polyair so as to reflect infrared heat.

Although the serpentine tubes 12 are twinned so that they track in parallel closely adjacent arrays 14 as they snake back and forth across the bottom sheet 18b of mat 10, the twinned arrays do not twist or criss-cross so that, not withstanding that a high tubing density is obtained in the twinned serpentine pattern, the tubing layer at all times remains only the thickness of a single tube. This maintains the maximum heat-transfer efficiency, that is 100 percent of the length of the tubing is in heat transmitting contact with the lower sheet of the mat thereby maximizing the rate at which heat is transferred to the surface of the frozen ground through the bottom sheet of the mat.

The twinned array of serpentine tubes are secured in place in their sandwich between the lower and upper sheets of the mat by means of for example laterally extending straps 24 secured to form loops 24a snugly over the tubes spaced along the length of the mat, advantageously where the straps 24 hold the tubes 12 down against the lower sheet 18b so as to maintain them in direct contact with the lower sheet. Other forms of fastening of the tubes to the lower sheet of the mat would work however.

As may be seen in the illustrations, the twinning of the tubes so as to not criss-cross the tubes is accomplished by alternating each tube between having a smaller radius turn 26a at one end or side of the zigzag of tubes 12 with a larger radius turn 26b at the opposite side or end of the zigzag so that for example the illustrated pair of tubes 14 track substantially parallel to one another throughout each of the turns in the serpentine arrangement by which the tubes zigzag back and forth across the surface of the lower sheet 18b of the mat so as to maximize the length of heated tubing per unit area on the lower sheet.

It is expected that the mats may be treated relatively harshly and may be left outside for an extended periods of time in a harsh environment. Consequently, the tubes must be relatively durable and may as described as above, have significant wall thicknesses of resilient material, the result being that there is a minimum radius which the bending of the tubes can accomplish in the plane of the mat without causing kinking or other structural failure of the tubes. The mats should also be able to be rolled up and therefore the tube and their wall thicknesses cannot be too thick.

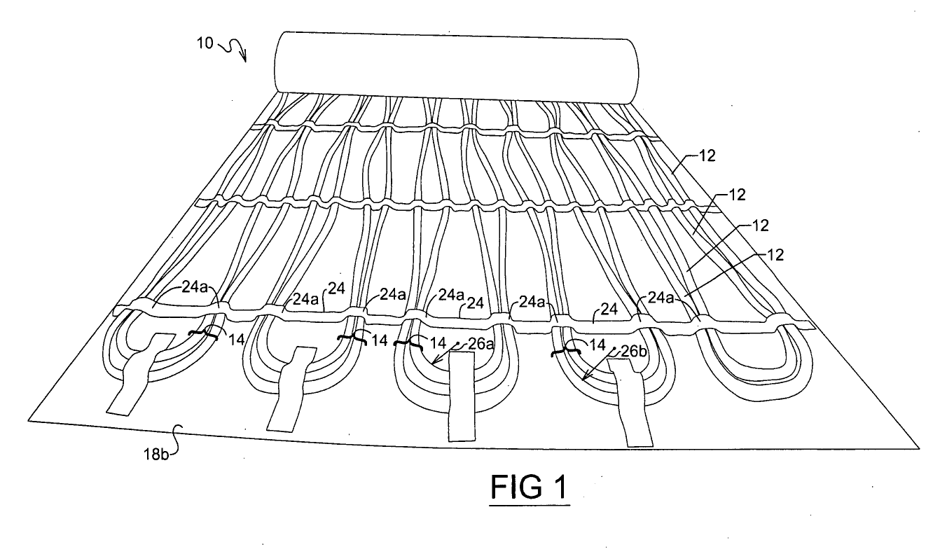

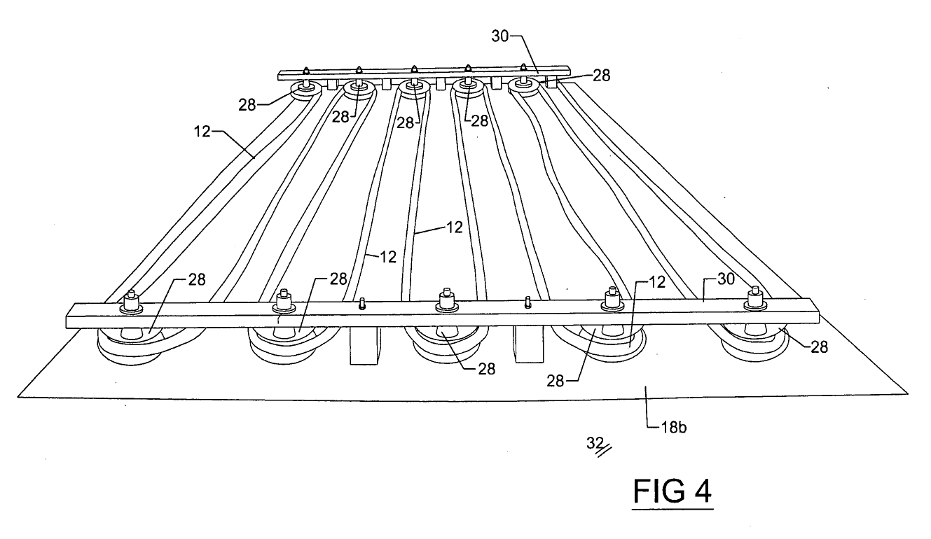

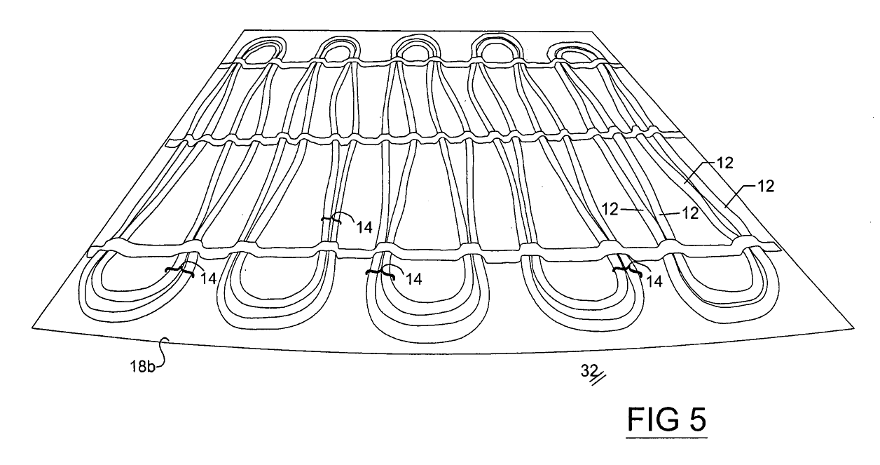

As seen in FIG. 4, tubing 12 may be arranged in a zigzag pattern across lower sheet 18b for example by means of the tubing being wrapped around pulleys 28 mounted latterly spaced across pulley jigs 30. Pulley jigs 30 are mounted at opposite ends of lower sheet 18b for example by rigidly mounting the jigs to a supporting table surface 32 or the like. Tubing 12 is then snake in a serpentine or zigzag pattern back and forth so as to loop the tubing around each pulley 28 in sequential order so that the tubing is sequentially extended back and forth in its serpentine pattern so as to result in a generally evenly parallel spaced apart array of tubing 12 extending substantially the entire length of lower sheet 18b. Once the tubing has been snaked through pulleys 28 and tensioned so as to substantially straighten the tubing between the pulleys, straps such as strap 24 may be mounted over the tubing for example by extending a spaced apart array of straps 24 such as seen in FIG. 1 laterally across the width of sheet 18b so as to loop the strap over each tube as the strap intersects the tube, and then mount the strapping down against lower sheet 18b for example by means of stitching or adhesive or the like. In the twinned tubing embodiment of FIG. 5, a pair of lengths of tubing 12 are snaked back and forth in a serpentine pattern sequentially between pulleys 28 so that, instead of the single tubing serpentine array of FIG. 4, a twinned tubing serpentine array such as seen in FIGS. 1 and 5, is tension between the pulleys, following which straps 24 are mounted down onto lower sheet 18 so as to clamp the twinned parallel arrays of tubing to the lower sheet. In this fashion, with the relatively easy to use pulley jigs 30, a high density, that is, a high heat transfer rate mat of heat transfer tubes may be efficiently mounted to a flexible lower sheet so as to maximise the heat transfer rate to the frozen ground surface 16.

As will be apparent to those skilled in the art in the light of the foregoing disclosure, many alterations and modifications are possible in the practice of this invention without departing from the spirit or scope thereof. Accordingly, the scope of the invention is to be construed in accordance with the substance defined by the following claims.

What is claimed is:

1. A ground thawing mat comprising at least a flexible upper sheet overlaying a serpentine twinned array of flexible heating fluid conduits wherein said twinned array comprises at least a closely adjacent and parallel pair of said conduits extending from a heating fluid inlet entering said parallel pairs of said conduits to a heating fluid outlet exiting said parallel pair of said conduits, wherein said parallel pair of said conduits extend substantially linearly without crossing one another between opposed serpentine turns where said parallel pair turn through said turns without crossing one another so that said twinned array lie substantially in a single plane overlaid by said upper sheet.

2. The mat of claim 1 further comprising a flexible lower sheet and wherein said twinned array of said conduits overlays said lower sheet so as to be interleaved between said upper and lower sheets and wherein said twinned array of said conduits are fastened by fasteners to said lower sheet.

3. The mat of claim 2 further comprising an insulating layer interleaved between said twinned array of said conduits and said upper sheet.

4. The mat of claim 3 further comprising a heat reflective foil sheet interleaved between said twinned array of said conduits and said insulating layer.

5. The mat of claim 4 wherein said, said upper and lower sheets have contiguous circumferential edges and wherein said edges of said upper and lower sheets are joined to substantially seal said edges together.

6. The mat of claim 5 wherein said fasteners include straps mounted to said lower sheet so as to form loops snugly looping over said twinned array of said conduits spaced part along the length of said twinned array.

7. The mat of claim 6 wherein said straps are a spaced apart array of straps extending across said twinned array.

8. The mat of claim 7 wherein said upper and lower sheets are substantially rectangular and wherein said, said conduits extend said substantially linearly in a longitudinal direction relative to said upper and lower sheets, and wherein said serpentine turns are disposed at opposite longitudinal ends of said upper and lower sheets.

9. The mat of claim 8 wherein said array of straps are spaced apart longitudinally along said lower sheet and wherein each strap of said array of straps extends substantially so as to form a plurality of said loops over said substantially linearly extending said conduits.

10. The mat of claim 9 further comprising end fasteners securing said serpentine turns to said lower sheet.

11. The mat of claim 10 wherein said end fasteners are short lengths of strapping mounted at ends thereof to said lower sheet at said serpentine turns and forming a loop over each turn of said serpentine turns.

12. A method of making a ground thawing mat which includes at least a flexible upper sheet overlaying a serpentine twinned array of flexible heating fluid tubes wherein said twinned array comprises at least a closely adjacent and parallel pair of said tubes extending from a heating fluid inlet entering said parallel pair of said tubes to a heating fluid outlet exiting said parallel pair of said tubes, wherein said parallel pair of said tubes extend substantially linearly without crossing one another between opposed serpentine turns where said parallel pair turn through said turns without crossing one another so that said twinned array lie substantially in a single plane overlaid by said upper sheet, the method comprising the steps of:
a) providing a spaced apart pair of tube tensioning jigs having turn forming means on each jig of said pair of tube tensioning jigs,
b) providing a pair of lengths of said tubes,
c) aligning said pair of lengths of said tubes so as to be closely adjacent and parallel,
d) feeding said pair of lengths of said tubes in a serpentine path alternatingly through opposite said turn forming means so as to alternatingly form said serpentine turns in said twinned array of said tubes and so as to form said twinned array in said plane and so as to not cross one said tube over the other.

13. The method of claim 12 further comprising providing a flexible lower sheet and positioning said jigs at opposite ends of said lower sheet and overlaying said twinned array of said conduits onto said lower sheet so as to be tensioned between said jigs and thereafter fastening said twinned array of said tubes by fasteners to said lower sheet and interleaving said twinned array between said upper and lower sheets.

14. The method of claim 13 further comprising interleaving an insulating layer between said twinned array of said tubes and said upper sheet.

15. The method of claim 14 further comprising interleaving a heat reflective foil sheet between said twinned array of said tubes and said insulating layer

16. The method of claim 15 further comprising sealing together contiguous circumferential edges of said upper and lower sheets.

17. The method of claim 16 wherein said fasteners include straps mounted to said lower sheet and forming loops by snugly looping said straps over said twinned array of said tubes spaced apart along the length of said twinned array.

18. The method of claim 17 wherein said straps are extended across said twinned array in a spaced apart array of straps.

19. The method of claim 18 further comprising providing end fasteners and securing said serpentine turns to said lower sheet.

20. The method of claim 19 wherein said end fasteners are short lengths of strapping and mounting said strapping and mounting said straps at ends thereof to said lower sheet at said serpentine turns so as to form a loop over each turn of said serpentine turns.
